(19) United States
(12) Patent Application Publication
(10) Pub. No.: US 2025/0387971 A1
(43) Pub. Date: Dec. 25, 2025

(54) ADDITIVE MANUFACTURING SYSTEMS COMPRISING AT LEAST TWO NOZZLES AND METHODS FOR ADDITIVE MANUFACTURING

(71) Applicant: XTPL S.A., Wroclaw (PL)

(72) Inventors: Krzysztof Kubica, Wroclaw (PL); Sebastian Wlodarczyk, Wroclaw (PL); Witold Nawrot, Zurawiniec (PL)

(73) Assignee: XTPL S.A., Wroclaw (PL)

(21) Appl. No.: 19/243,997

(22) Filed: Jun. 20, 2025

Related U.S. Application Data
(60) Provisional application No. 63/663,806, filed on Jun. 25, 2024.

(51) Int. Cl. B29C 64/209; B29C 64/124; B29C 64/232; B29C 64/236; B29C 64/336; B33Y 10/00; B33Y 30/00

(52) U.S. Cl. CPC B29C 64/209; B29C 64/124; B29C 64/232; B29C 64/236; B29C 64/336; B33Y 10/00; B33Y 30/00

(57) ABSTRACT

Additive manufacturing systems comprising at least two nozzles and methods for additive manufacturing are provided. An example system comprises a first cartridge assembly, a second cartridge assembly, a first nozzle positioning system, a second nozzle positioning system, and a control circuit. The first cartridge assembly comprises a first nozzle. The second cartridge assembly comprises a second nozzle. The first nozzle positioning system is operatively coupled to the first cartridge assembly and capable to move the first nozzle independently of the second nozzle and in at least three degrees of freedom relative to the second nozzle. The second nozzle positioning system operatively coupled to the second cartridge assembly capable to move the second nozzle independently of the first nozzle and in at least three degrees of freedom relative to the first nozzle.

### CROSS REFERENCE TO RELATED APPLICATIONS

This application claims priority to U.S. Provisional Patent Application No. 63/663,806, which was filed on Jun. 25, 2024. The entire contents of which is hereby incorporated by reference into this specification.

### BACKGROUND

Additive manufacturing systems can be used to create microscale electrical connections on the surfaces of circuit boards and non-conductive materials. There are challenges in creating microscale electrical connections on surfaces of a PCB, silicon-based electronic components, flexible substrates, and other substrates that are the basis of microelectronic device drivers.

### SUMMARY

The present disclosure provides an additive manufacturing system. The system comprises a first cartridge assembly, a second cartridge assembly, a first nozzle positioning system, a second nozzle positioning system, and a control circuit. The first cartridge assembly comprises a first nozzle. The first cartridge assembly is capable to dispense an ink composition through the first nozzle. The second cartridge assembly comprises a second nozzle. The second cartridge assembly is capable to dispense an ink composition through the second nozzle. The first nozzle positioning system is operatively coupled to the first cartridge assembly and capable to move the first nozzle independently of the second nozzle and in at least three degrees of freedom relative to the second nozzle. The second nozzle positioning system operatively coupled to the second cartridge assembly capable to move the second nozzle independently of the first nozzle and in at least three degrees of freedom relative to the first nozzle. The control circuit is in electrical communication with the first cartridge assembly, the second cartridge assembly, the first positioning system, and the second positioning system. The control circuit is capable to dispense an ink composition through the first nozzle and the second nozzle utilizing the first cartridge assembly and the second cartridge assembly.

The present disclosure also provides a method for additive manufacturing. The method comprises disposing a first nozzle of a first cartridge assembly of an additive manufacturing system over a first location on a substrate. Independently of the first nozzle, the method comprises disposing a second nozzle of a second cartridge assembly of an additive manufacturing system over a second location on a substrate. The method comprises dispensing a first ink composition from the first nozzle onto the first location of the substrate and dispensing a second ink composition from the second nozzle onto the second location of the substrate, thereby forming a first portion of a structure on the first location and a second portion of the structure on the second location. The method comprises repeating, as necessary, repositioning of the first nozzle and the second nozzle over the substrate and dispensing ink composition from the first nozzle, the second nozzle, or a combination thereof, thereby forming the structure on the substrate.

It is understood that the present disclosure is not limited to the examples summarized in this Summary. Various other aspects are described and exemplified herein.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is a schematic representation of an example of an additive manufacturing system according to the present disclosure;

FIG. 2A is a detailed schematic representation of an example of a nozzle positioning system and a cartridge assembly according to the present disclosure;

FIG. 2B is a detailed schematic representation of a linkage assembly of FIG. 2A;

FIG. 2C is a detailed schematic representation of the example of the nozzle positioning system and the cartridge assembly of FIG. 2A with arrows included to show some example movements of the nozzle positioning system and the cartridge assembly;

FIG. 3 is a detailed schematic representation of an example of a nozzle positioning system and a cartridge assembly according to the present disclosure;

FIG. 4 is a front view of an example of two cartridge assemblies according to the present disclosure;

FIG. 5A is an isometric view of a cartridge assembly and a nozzle positioning system according to the present disclosure;

FIG. 5B is an isometric view of the cartridge assembly and the nozzle positioning system of FIG. 5A with a casing hidden;

FIG. 5C is an side view of the cartridge assembly and the nozzle positioning system of FIG. 5A;

FIG. 5D is an side view of the cartridge assembly and the nozzle positioning system of FIG. 5A with a hidden casing;

FIG. 6A is a an isometric view of a print head comprising four cartridge assemblies and four nozzle positioning systems according to the present disclosure;

FIG. 6B is a front view of the print head of FIG. 6A;

FIG. 7 is a schematic diagram of an additive manufacturing system according to the present disclosure; and

FIG. 8 is flow chart illustrating a method of additive manufacturing according to the present disclosure.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION

Certain exemplary aspects of the present disclosure will now be described to provide an overall understanding of the principles of the structure, function, manufacture, and use of the compositions, methods, and products disclosed herein. One or more examples of these aspects are illustrated in the accompanying drawings. Those of ordinary skill in the art will understand that the devices and methods specifically described herein and illustrated in the accompanying drawings are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Any references herein to “various examples,” “some examples,” “one example,” “an example,” similar references to “aspects,” or the like, means that a particular feature, structure, or characteristic described in connection with the example is included in at least one example. Thus, appearances of the phrases “in various examples,” “in some examples,” “in one example,” “in an example,” similar references to “aspects,” or the like, in places throughout the specification are not necessarily all referring to the same example. Furthermore, the particular features, structures, or characteristics may be combined in any suitable manner in one or more examples. Thus, the particular features, structures, or characteristics illustrated or described in connection with one example may be combined, in whole or in part, with the features, structures, or characteristics of one or more other examples without limitation. Such modifications and variations are intended to be included within the scope of the present examples.

Increasing the number of nozzles on an additive manufacturing system that can simultaneously print structures can enable quicker printing of the structure. Additionally, increasing the number of nozzles on an additive manufacturing system can enable the use of different materials in different nozzles, which can reduce the need to change materials within a single nozzle enabling more efficient printing. Accordingly, the present disclosure provides an additive manufacturing system that includes at least two nozzles, which can enable more rapid and/or efficient printing.

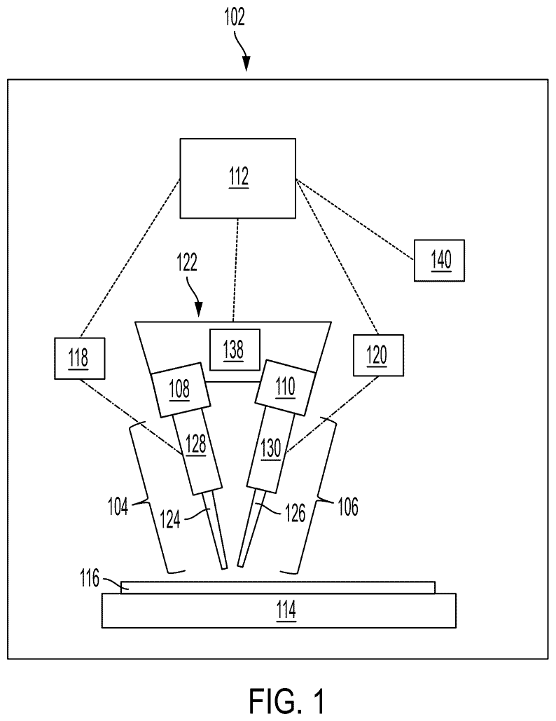

Referring to FIG. 1, an example additive manufacturing system 102 according to the present disclosure is shown. The additive manufacturing system 102 can be configured to perform the methods as described herein and can comprise various hardware components in addition to cartridge assembly 104, cartridge assembly 106, nozzle positioning system 108, nozzle positioning system 110, and control circuit 112, to perform the methods as described herein. For example, the additive manufacturing system 102 can optionally comprise a stage 114 configured to support and/or move a substrate 116, a feed system (e.g., a pumping system) 118, a feed system 120, a print head 122, and a print head positioning system 138 configured to move the print head 122 relative to the substrate 116.

The control circuit 112 can be in electrical communication with the cartridge assembly 104, cartridge assembly 106, nozzle positioning system 108, nozzle positioning system 110, stage 114, feed system 118, feed system 120, print head 122, and print head positioning system 138. The control circuit 112 can move various components, such as, the nozzle positioning system 108, the nozzle positioning system 110, and the print head positioning system 138, individually or together and such movements may occur simultaneously or in sequence.

Each cartridge assembly 104, 106 can comprise a nozzle 124, 126 and a cartridge 128, 130. Each cartridge assembly 104, 106 can be capable to dispense an ink composition through their respective nozzle 124, 126. Each nozzle 124, 126 can comprise a capillary tube. The capillary tube can comprise an internal diameter in a range of 0.1 μm to 10 μm, such as, for example, 1 μm to 10 μm or 1 μm to 3 μm. The capillary tube can comprise an outer diameter in a range of 0.2 μm to 20 μm, such as, for example, 1 μm to 10 μm, 0.7 μm to 8 μm, 1 μm to 8 μm, or 1 μm to 5 μm.

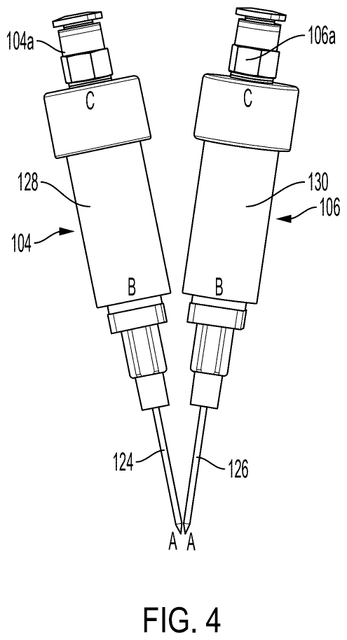

Each cartridge 128, 130 can be capable of storing ink composition to dispense through their respective nozzle 124, 126. For example, each cartridge 128, 130 can comprise a cavity suitable for receiving an ink composition and a piston (e.g., plunger) suitable to urge the ink composition out of the cavity and into and through the respective nozzle 124, 126. An example of cartridge assemblies 104 and 106 are shown in FIG. 4. As illustrated, each cartridge assembly 104, 106, can comprise a port 104a, 106a suitable for fluidic communication with a respective feed system 118, 120, such that the feed system 118, 120 can apply a force to the plunger in each cartridge 128, 130.

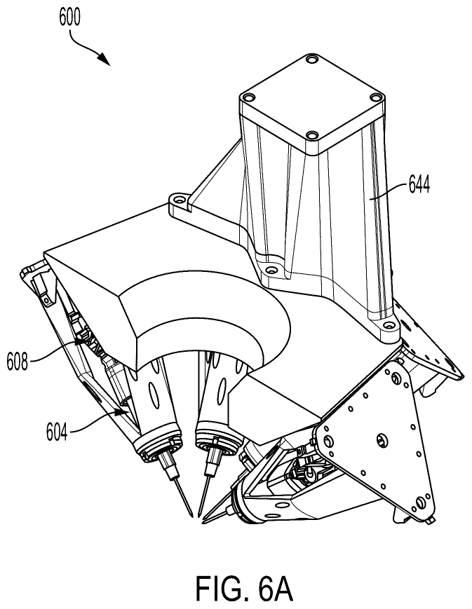

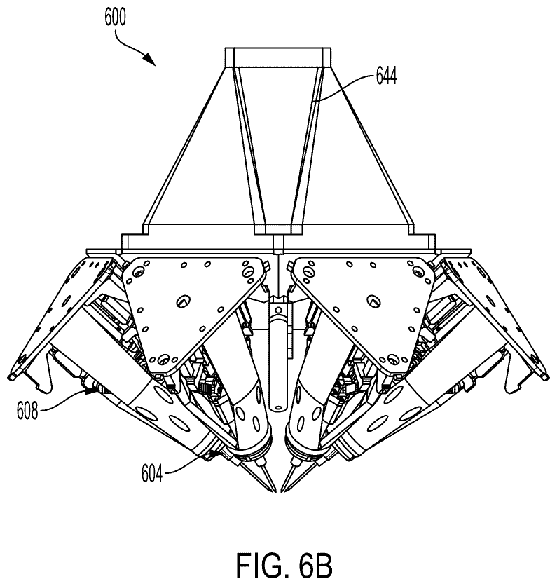

Referring again to FIG. 1, only two cartridge assemblies 104 and 106 are illustrated for ease of clarity and discussion herein, although more than two may be included. The additive manufacturing system 102 can comprise at least two cartridge assemblies, at least three cartridge assemblies, at least four cartridge assemblies, at least five cartridge assemblies, or at least six cartridge assemblies. For example, the additive manufacturing system 102 can comprise two cartridge assemblies as illustrated in FIG. 1 or four cartridge assemblies as illustrated in FIG. 6A-6B.

Referring again to FIG. 1, each nozzle positioning system 108, 110 can be operatively coupled to a respective cartridge assembly 104, 106. Each nozzle positioning system 108, 110 can be capable to move their respective nozzle 124, 126 independently of each other nozzle 124 or 126 and in at least three degrees of freedom. For example, the nozzle positioning system 108 can be capable to move the nozzle 124 independently of nozzle 126 and in at least three degrees of freedom relative to nozzle 126. The nozzle positioning system 110 can be capable to move the nozzle 126 independently of nozzle 124 and in at least three degrees of freedom relative to nozzle 124. The nozzles 124, 126 are capable to simultaneously contact the substrate 116 utilizing movement of the nozzles positioning systems 108, 110 and/or the print head positioning system 138. Moving each nozzle 124, 126 independently can enable calibration of the position of the nozzles 124, 126.

Degrees of freedom refers to mechanical degrees of freedom of an object in three-dimensional space. The degrees of freedom comprise translational and rotation movements. For example, a degree of freedom can comprise X-axis position (e.g., left/right position), Y-axis position (e.g., forward/back position), Z-axis position (e.g., up/down position), pitch (e.g., rotation about X-axis), roll (e.g., rotation about Y-axis), and yaw (e.g., rotation about Z-axis).

Each nozzle positioning system 108, 110 is capable to move their respective nozzle 124, 126 while ink composition is being dispensed through the respective nozzle 124, 126 (e.g., extruded through the nozzle). For example, the control circuit 112 can be capable to move the nozzle 124 and/or 126 simultaneously while the respective feed system 118, 120 urges ink composition through the respective nozzle 124, 126 to dispense the ink composition on the substrate 116. The movement of the nozzles 124, 126 during printing can enable formation of different portions of a structure simultaneously utilizing different nozzles 124, 126.

The additive manufacturing system 102 can be configured to reduce the amount of components and/or size of components proximal to the nozzles 124, 126 such that the components will not interfere with the nozzles 124, 126 during movement of the nozzles 124, 126. For example, during dispensing, the nozzle 124 can be intermediate the stage 114 and the nozzle positioning system 108 (e.g., positioned away from the working end of the nozzle 124) and the nozzle 126 can be intermediate the stage 114 and the nozzle positioning system 110 (e.g., positioned away from the working end of the nozzle 126). Positioning the nozzle positioning systems 108, 110 away from the working end of the nozzle and/or stage 114 can enable increased range of movement of the nozzles 124, 126. The size of a nozzles 124, 126, the size of the cartridges 128, 130, proximity of nozzles 124, 126 relative to one another can affect the range of motion of a nozzle 124, 126 and/or the quantity of nozzles that may be included in the additive manufacturing system 102.

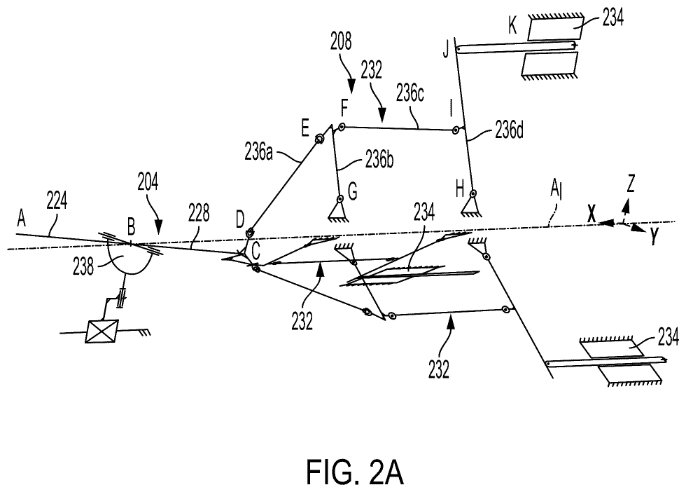

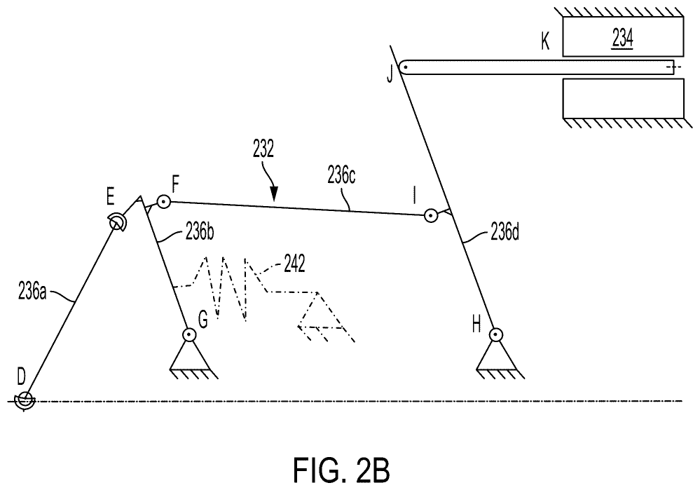

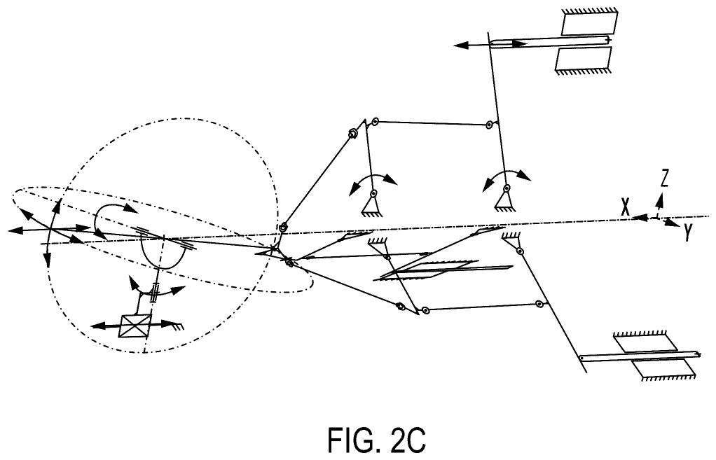

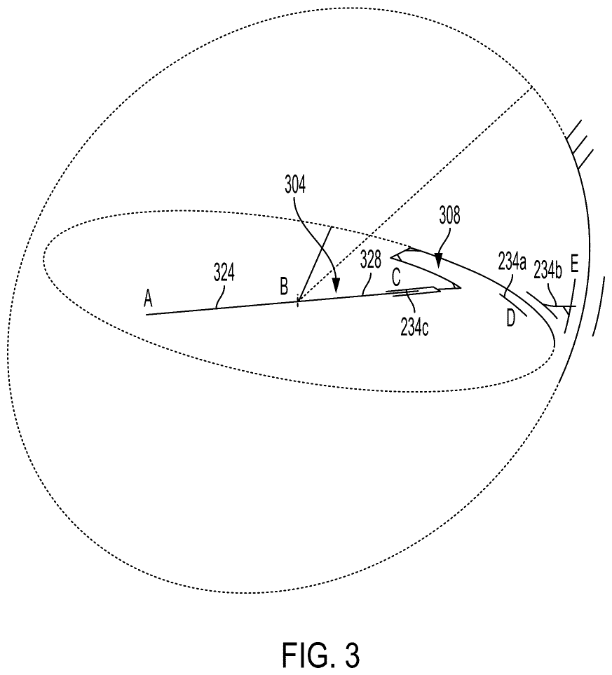

Each nozzle positioning system 108, 110 can be the same or different. The nozzle positioning systems 108, 110, can be based on linear movements as discussed with respect to FIGS. 2A-2B, rotational movements as discussed with respect to FIG. 3, or a combination thereof.

For example, referring to FIG. 2A, a schematic diagram of a nozzle positioning system 208 is provided. As illustrated, the nozzle positioning system 208 is operatively coupled (e.g., mechanically coupled via a fastener, weld, joint, etc.) to the cartridge assembly 204. The nozzle positioning system 208 can comprise at least two actuators, such as, for example, at least three actuators. As illustrated, the nozzle positioning system 208 comprises three actuators 234. Each actuator 234 can be capable to adjust a position and/or orientation of the nozzle 224. The actuators 234 can be linear actuators.

The nozzle positioning system 208 can comprise at least two linkage assemblies, such as, for example, at least three linkage assemblies. As illustrated, the nozzle positioning system 208 comprises three linkage assemblies 228. The cartridge assembly 204 can define a longitudinal axis, A_{I}, The linkage assemblies 232 can be positioned about the longitudinal axis, A_{I}. For example, the linkage assemblies 232 can be substantially evenly spaced about the longitudinal axis, A_{I}.

The actuators 230 can be operatively coupled to the cartridge assembly 204 by linkage assemblies 232. Each linkage assembly 232 can be intermediate the nozzle 224 and a respective actuator 234. The linkage assemblies 232 can operate to translate motion from the actuators 234 into a position and/or orientation change of the nozzle 224. The linkage assemblies 232 can amplify the movement of the actuators 230 and enable the actuators 234 to be positioned away from the working end A of the nozzle 224.

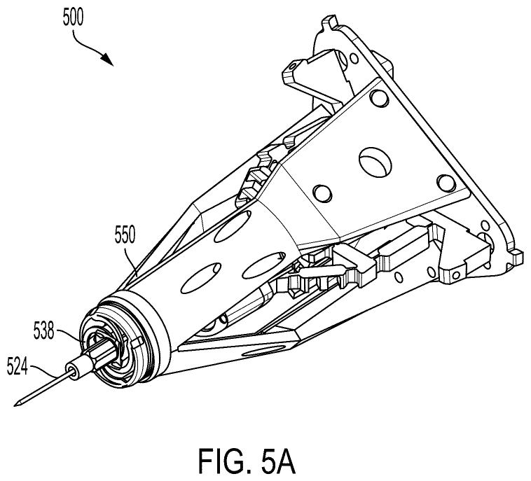

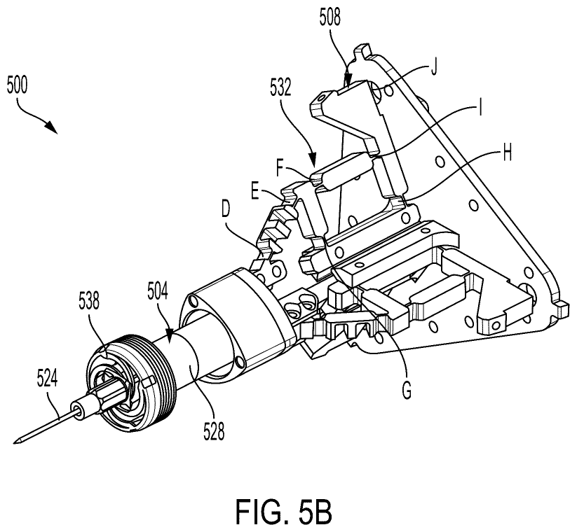

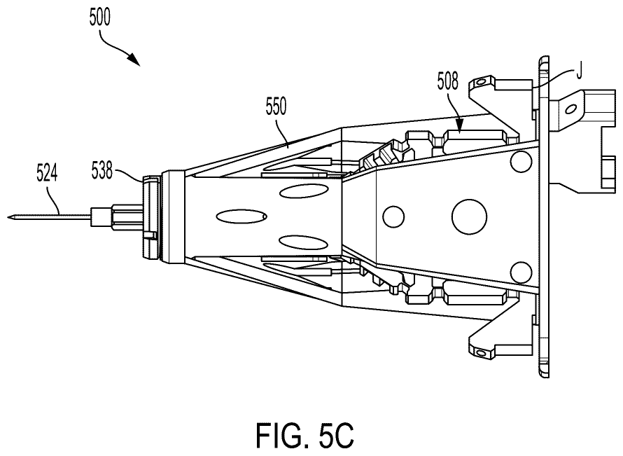

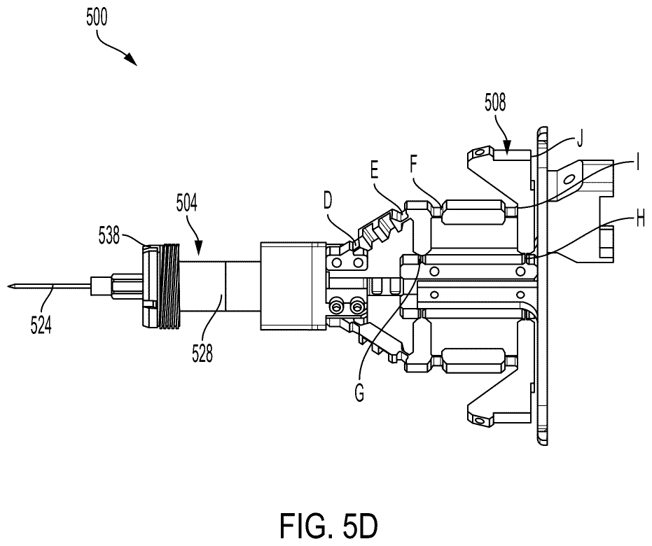

A pivot point B can be defined by pivotably coupling the cartridge assembly 204 to a revolute joint 238, which can inhibit certain motion of the cartridge assembly 204 while enabling rotations about the pivot joint B. Revolute joint 238 may linearly move along the longitudinal axis, A1. The revolute joint 238 can be coupled to a casing 550 as illustrated in FIGS. 5A and 5C as discussed below.

The cartridge assembly 204 can be operatively coupled to each linkage assembly 232 by a joints D. The position of the distal end C of the cartridge assembly 204 can be defined by the joints D. Joints D may be spherical joints.

Each linkage assembly can comprises at least two components selected from the group consisting of a joint, a bar, a spring, and a combination thereof. A detailed view of one linkage 228 is provided in FIG. 2B.

As illustrated, the linkage assembly 232 comprises four bars, 236a, 236b, 236c, and 236d, joints D, E, F, G, H, and I. The joints D, E, F, G, H, and I may be spherical joints or revolute joints. Spherical joints can enable rotation about the point of the joint (e.g., movement in three degrees of freedom). A revolute joint can enable rotation around 1 axis (e.g., movement in one degree of freedom). For example, joints D and E can be spherical joints and joints F, G, H, and I can be revolute joints.

Bar 236d is operatively coupled to the actuator 234 at Point J. A spring 242 can optionally be included in the linkage assembly 232 to tension the linkage assembly 232 and enable substantially constant contact between the bar 236d and the actuator 234. Some example movements of the nozzle positioning system 208, including linkage assembly 232 and actuator 234, and the cartridge assembly 204 are shown in FIG. 2C.

Referring to FIG. 3, a schematic diagram of a nozzle positioning system 308 is provided. As illustrated, the nozzle positioning system 308 is operatively coupled (e.g., mechanically coupled via a fastener, weld, joint, etc.) to the cartridge assembly 304. The nozzle positioning system 308 can comprise at least two actuators. As illustrated, the nozzle positioning system 308 comprises three actuators 334a-c. Each actuator 334a-c can be capable to adjust a position and/or orientation of the nozzle 324. The actuators 334a-b can be goniometers and the actuator 334c can be a linear stage.

Referring to FIG. 5A-5D, a print head assembly 500 comprising a nozzle positioning system 508 and a cartridge assembly 504 is provided. The cartridge assembly 504 comprises a nozzle 524 and a cartridge 528. The construction of the nozzle positioning system 508 is similar to that shown schematically in FIGS. 2A-2B and the nozzle positioning system 508 comprises linkages 532. As illustrated, joint 538 can comprise a spiral flexure, which can enable linear movement of the center of the flexure and rotation of the attached elements around joint 538. Joints E, F, G, H, and I can comprise a blade flexures. The joint 538 can be attached to the casing 550. The casing 550 can be a solid structure that supports the position of the joint 538.

Referring to FIG. 6A-6B, an assembly 600 comprising four nozzle positioning systems 608, four cartridge assemblies 604, and a mounting post 644 is provided.

Referring back to FIG. 1, the additive manufacturing system 102 can optionally comprise a feed system associated with each cartridge assembly 104, 106. The feed system 118 can be in fluidic communication with the cartridge assembly 104 and the feed system 120 can be in fluidic communication with the cartridge assembly 106. Two feed systems 120 are shown in FIG. 1 for ease of clarity, although more than two feed systems may be included, each capable to facilitate dispensing of ink composition through a respective nozzle 124, 126. For example, the feed system 118, 120 can be capable to apply a pressure in a range of 100 mbar to 10,000 mbar to the ink composition in the respective nozzle 124, 126 to extrude the ink composition through the respective nozzle 124, 126 and onto the substrate 116, such as, for example, a pressure in a range of 100 mbar to 7,500 mbar, 200 mbar to 5,000 mbar, 200 mbar to 3,000 mbar, 300 mbar to 2,500 mbar, 320 mbar to 2,000 mbar, or 320 mbar to 1,200 mbar. Pressures as used herein refer to gauge pressure unless stated to the contrary.

The stage 114 can be capable of supporting the substrate 116 and can comprise a stage positioning system capable to move the stage 114 independently of the nozzle positioning systems 108, 110.

The print head 122 can comprise the cartridge assembly 104, the cartridge assembly 106, the nozzle positioning system 108, and the nozzle positioning system 110, and a print head positioning system 138 capable to move the print head 122 relative to the stage 114. The print head 122 can be enable simultaneous movement of the cartridge assembly 104, the cartridge assembly 106, the nozzle positioning system 108, and the nozzle positioning system 110 by the print head positioning system 138. The print head 122 can optionally comprise the feed systems 118 and 120 or the feed systems 118 and 120 can be separate from the print head 122.

The control circuit 112 can be capable to dispense an ink composition through the nozzles 124, 126 utilizing the cartridge assembly 104 and the second cartridge assembly 106. The control circuit 112 can individually control each cartridge assembly 104, 106, feed system 118, 120, and each nozzle positioning system 110. For example, the control circuit 112 can dispense ink composition through the nozzles 124, 126 using the same parameters or different parameters. For example, the control circuit 112 can dispense ink through the nozzle 124 at a first rate and the second nozzle 126 at a second rate. The first rate and the second rate can be the same or different.

The control circuit 112 can control the position and/or orientation of each nozzle with respect to the substrate 116 individually. For example, the control circuit 112 can be capable to adjust a position and/or orientation of the nozzle 124 with respect to the substrate 116 and/or stage 114 separately from a position and/or orientation of the nozzle 126 with respect to the substrate 116 and/or stage 114. The control circuit 112 can dispense ink composition onto the substrate 116 through the nozzle 124 and the second nozzle 126, while the nozzle 124 is at a first distance from the substrate 116 and the second nozzle 126 is at a second distance from the substrate, wherein the first distance and the second distance are the same or different.

During deposition of ink composition, the control circuit 112 can be capable to dispense ink composition onto the substrate 116 through the nozzle 124 and the nozzle 126, while the relative position between the nozzles 124, 126 remains constant or is changing.

The additive manufacturing system 102 can optionally comprise a detector 140 capable to determine the position, orientation, or a combination thereof of the nozzles 124, 126. For example, the detector can be a vision system. The vision system can comprise a camera.

The detector 140 can be capable to calibrate the nozzles 124, 126 for printing and enable desired alignment between the nozzles 124, 126. For example, the nozzles 124, 126 be positioned and orientated into a calibration pose (e.g., touch a substrate at a certain location), the position can be observed by the detector 140, and each nozzles 124, 126 relative position to one another and/or the print head 122 can be determined and utilized for calibration of the nozzles 124, 126. The additive manufacturing system 102 can employ machine vision and machine algorithms to learning to enhance the calibration of the nozzles 124, 126. For example, additive manufacturing system 102 can automatically search for and/or recognize a working end and/or tip of a nozzle, which can be used for finding the absolute position of the cartridge assemblies, 104, 106. The machine vision and machine learning algorithms can be utilized to automatically tune the pressure of the feed systems 118, 120 to obtain a desired line width of the ink composition on the substrate 116.

The substrate 116 can be a printed circuit board (PCB) or other electronic hardware component, such as, for example, an electrical circuit, a thin conductive film, a display, a micro-LED, an LED, an antenna, a sensor, a micropump, a photonic IC, a quantum dot display, smart glass, memory chip, or other electronic article. In some examples, the substrate 116 can comprise silicon, quartz, or glass. In various examples, the substrate 116 can be at least partially coated with silicon and have various electronic components (e.g., pads, vias, resistors, capacitors, LEDs). The substrate 116 can comprise various shape, such as, for example, circular, triangular, rectangular, pentagonal, hexagonal, or other shape.

The print head 122, the nozzle positioning system 108, and/or nozzle positioning system 110, including the nozzles 124, 126, may move and dispense the ink composition according to machine path instructions stored in memory (e.g., non-transitory memory) of the additive manufacturing system 102 and/or of memory of a device in signal communication with the additive manufacturing system 102. For example, the machine path instructions, when executed by the control circuit 112 and/or a control circuit 112 of a device in signal communication with the additive manufacturing system 102, can cause the control circuit 112 to move the print head 122, the nozzle positioning system 108, nozzle positioning system 110, nozzle 124, and/or nozzle 126 to a desired position and dispense the ink composition according to the machine path instructions.

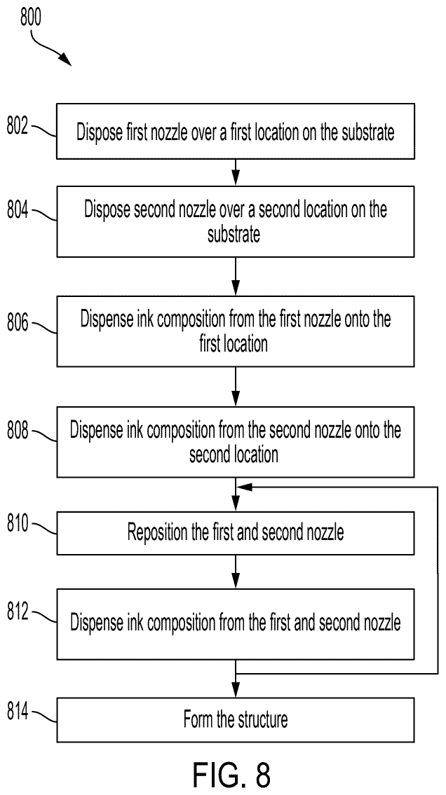

As illustrated in FIG. 8, the additive manufacturing system 102 can be configured to perform a method 200 of additive manufacturing as described herein. The method 200 comprises disposing 802 the nozzle 124 of the cartridge assembly 104 of the additive manufacturing system 102 over a first location on the substrate 116. The method 200 comprises disposing 804 the nozzle 124 of the cartridge assembly 104 of the additive manufacturing system 102 over a first location on the substrate 116, which may be performed independently of the nozzle 124 in that the nozzle 126 can be adjusted in positioning separately from the nozzle 124 or the same as nozzle 126 as desired.

The method 800 comprises dispensing 806 an ink composition from the nozzle 124 onto the first location of the substrate 116 and dispensing 808 an ink composition from the nozzle 126 onto the second location of the substrate 116, thereby forming a first portion of a structure on the first location and a second portion of the structure on the second location.

As used herein, the terms “on,” “dispensed over,” “dispensed onto,” “formed over,” “formed onto,” “deposited over,” “deposited onto,” “overlay,” “provided over,” “provided onto,” and the like, mean formed, overlaid, dispensed, deposited, or provided on but not necessarily in contact with the surface. For example, a composition “deposited onto” a substrate surface does not preclude the presence of one or more layers of the same or different composition located between the composition and the substrate.

The method 800 comprises repeating, as necessary, repositioning 810 the nozzle 124 and the nozzle 126 over the substrate 116 and dispensing 812 ink composition from the nozzle 124, the nozzle 126, or a combination thereof, thereby forming the structure on the substrate 116.

With respect to the appended claims, those skilled in the art will appreciate that recited operations therein may generally be performed in any order. Also, although various operational flows are presented in a sequence(s), it should be understood that the various operations may be performed in other orders than those that are illustrated, or they may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

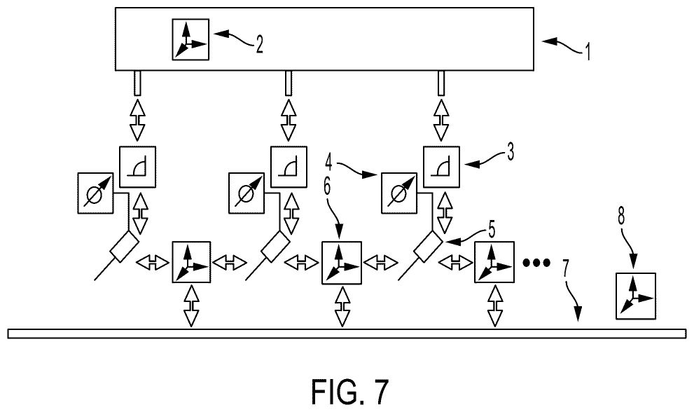

Referring to FIG. 7, a schematic diagram of a print head 1 is provided. The print head 1 can comprise a print head positioning system 2, print head angle adjustment systems 3, feed systems 4, cartridge assemblies 5, nozzle positioning systems 6, stage 7 and a stage positioning system 8. The print head positioning system 2 can comprise a gantry construction, moving relative to other device components, such as, for example, the substrate 7. The print head angle adjustment systems 3 can obtain a desired angle of the nozzle, relative to the print head 1 and the substrate/stage 7, which can enable more cartridge assemblies 5 to be placed into the print head 1. The feed system 4 can regulate the material flow rate through the nozzle and can be independent for each nozzle, which can enable precise regulation of the resulting flow of ink composition.

The cartridge assembly 5 can be comprised of a cartridge with an ink composition and the nozzle. The nozzle positioning system 2 can enable each nozzle to be independently manipulated, relative to the substrate 7 and the printhead 1. The nozzle positioning systems 2 can enable arrangement of the nozzles in a pattern and dynamically change their position during the dispensing process, if desired.

The stage 7 can be capable to level and transport the substrate, using the stage positioning system 8. The stage positioning system 8 can act in coordination with the print head positioning system 2 and the nozzle positioning system 6. The print head 1 can comprise one of the print head positioning system 2 and the stage positioning system 8, or both the print head positioning system 2 and the stage positioning system 8.

The ink composition can include various components. In various examples, the ink composition can comprise a fluorescent compound. For example, the ink composition can comprise semiconducting nanoparticles (e.g., semiconductor quantum dots, perovskite quantum dots) and/or not scattering agents (e.g., microparticles, nanoparticles, ZrO₂, SiO2, TiO₂, Zn₂O, CeO₂). The semiconducting nanoparticles can include one or more of the following structure types: core, core/shell, gradient alloyed, and/or doped, for example, lead sulfide (PbS), lead selenide (PbSe), lead telluride (PbTe), cadmium selenide (CdSe), cadmium sulfide (CdS), cadmium telluride (CdTe), HgS, HgSe, HgTe, HgSeS, HgSeTe, HgSTe, HgZnS, HgZnSe, HgZnTe, MgZnSe, MgZnS, CdZnS, CdZnSe, CdZnTe, CdHgS, CdHgSe, CdHgTe, HgZnTeS, CdZnSeS, CdZnSeTe, CdZnSTe, CdHgSeS, CdHgSeTe, CdHgSTe, HgZnSeS, HgZnSeTe, HgZnSTe, GaN, GaP, GaAs, GaSb, AlN, AIP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GalnPAs, GalnPSb, InAlNP, InAlNAs, InAlNSb, InAlPAs, InAlPSb, SnS, SnSe, SnTe, SnSeS, SnSeTe, SnSTe, PbSeS, PbSeTe, PbSTe, SnPbS, SnPbSe, SnPbTe, SnPbSSe, SnPbSeTe, SnPbSTe, ZnGaS, ZnAlS, ZnInS, ZnGaSe, ZnAlSe, ZnInSe, ZnGaTe, ZnAlTe, ZnInTe, ZnGaO, ZnALO, ZnInO, HgGaS, HgAlS, HgInS, HgGaSe, HgAlSe, HgInSe, HgGaTe, HgAlTe, HgInTe, MgGaS, MgAlS, MgInS, MgGaSe, MgAlSe, MgInSe, CuZnSnSe, CuZnSnS, (CdTeSeS), silver sulfide (Ag₂S), indium arsenide (InAs), indium phosphide (InP), indium zinc phosphide In (Zn) P, zinc selenide (ZnSe), zinc sulfate (ZnS), zinc telluride (ZnTe), zinc selenide telluride (ZnSeTe), zinc sulfide telluride (ZnSTe), Cu: ZnS, zinc oxide (ZnO₂), copper indium sulfide (CuInS), copper indium selenide (CuInSe₂), zinc cadmium selenide (ZnCdSe), zinc cadmium selenide sulfide (ZnCdSeS), zinc copper indium sulfide (ZnCuInS), silver indium sulfide (AgInS₂), CuIn(Ga)S₂, CuIn(Ga)Se₂, Cu₂ZnSnS₄, Cu₂ZnSnSe₄, PbMeX₃ (e.g., CsPbBr₃, CsPbI₃, CsPbCl₃, FAPbBr₃, CsPb(BrₓI₁₋ₓ)₃, FAPb(Brx-I₁₋ₓ)₃, CH₃NH₃PbI₃, CH₃NH₃PbBr₃, CH3NH3Pb₃₋ₓIₓ), silicone quantum dots, or carbon dots. Additionally, the structures mentioned above cover inorganic shells (e.g., ZnSe, ZnS, CdSe, CdS, or InP). The semiconducting nanoparticles can have a mean average particle size of no greater than 500 nanometers, as measured with transmission electron microscopy, such as, for example, no greater than 250 nanometers, no greater than 100 nanometers, no greater than 10 nanometers, or no greater than 7 nanometers.

In various examples, the ink composition can comprise a polymer, such as, for example, a UV-curable polymer resin or other type of photopolymer or light-activated resin. In one example, the polymer can be similar to any of the Norland Optical Adhesives manufactured by Norland Products and acrylic-based resins (e.g., tetradecyl acrylate), perfluoropolyether (PFPE)-urethane methacrylate resins, photoresist SU-8, poly (methyl methacrylate), epoxy-based resins, urethane derivatives, polyamides, acrylate-based polymers, and combinations thereof.

In various examples, the ink composition can comprise various conductive components, such as, for example, a metal, a metal alloy, a conductive carbon, or a combination thereof. For example, the ink composition can comprise metal nanoparticles, such as, for example, copper (e.g., elemental, an alloy, a compound) nanoparticles, gold (e.g., elemental, an alloy, a compound) nanoparticles, silver (e.g., elemental, an alloy, a compound) nanoparticles, or a combination thereof. The metal nanoparticles can have a mean average particle size of no greater than 500 nanometers, as measured with transmission electron microscopy, such as, for example no greater than 150 nanometers or no greater than 100 nanometers. The metal nanoparticles can comprise a metal bound to a polymer, such as, for example, polyvinylpyrrolidone.

The ink composition can comprise other components, such as, for example, a solvent (e.g., a polar protic solvent), a resin, or other compound. For example, the ink composition can comprise nanoparticles and a solvent. The ink composition can comprise at least 40% by weight nanoparticles based on the total weight of the ink composition, such as, for example, at least 50% by weight or at least 60% by weight nanoparticles all based on the total weight of the ink composition.

The ink composition can comprise a viscosity in a range of 20 cP to 10,000,000 cP, such as, for example, 100,000 cP to 10,000,000 cP, 20 cP to 100,000 cP, 20 cP to 40,000 cP, 50 cP to 10,000,000 cP, 50 cP to 100,000 cP, 50 cP to 4,000 cP, 100 cP to 3,000 cP, or 200 cP to 1,200 cP, for example, as measured at 25 degrees Celsius with a rheometer with a 25 mm parallel plate spindle and a shear rate in a range of 0.1 s⁻¹ to 100 s⁻¹.

The same ink composition can be used for each cartridge assembly 104, 106 or different ink compositions can be used for each cartridge assembly 104, 106. Thus, at least two different ink compositions can be printed at the same time or at least two different portions of a structure with the same ink composition may be printed at the same time.

Various aspects of the present disclosure include, but are not limited to, the aspects listed in the following numbered clauses.
Clause 1. An additive manufacturing system, the system comprising: a first cartridge assembly comprising a first nozzle, wherein the first cartridge assembly is capable to dispense an ink composition through the first nozzle; a second cartridge assembly comprising a second nozzle, wherein the second cartridge assembly is capable to dispense an ink composition through the second nozzle; a first nozzle positioning system operatively coupled to the first cartridge assembly and capable to move the first nozzle independently of the second nozzle and in at least three degrees of freedom relative to the second nozzle; a second nozzle positioning system operatively coupled to the second cartridge assembly capable to move the second nozzle independently of the first nozzle and in at least three degrees of freedom relative to the first nozzle; and a control circuit in electrical communication with the first cartridge assembly, the second cartridge assembly, the first positioning system, and the second positioning system, wherein the control circuit is capable to dispense an ink composition through the first nozzle and the second nozzle.
Clause 2. The system of clause 1, further comprising: a third cartridge assembly comprising a third nozzle, wherein the third cartridge assembly is capable to dispense an ink composition through the third nozzle; and a third positioning system operatively coupled to the third cartridge assembly and capable to move the third nozzle independently of the first and second nozzles and in at least three degrees of freedom relative to the first and second nozzles.
Clause 3. The system of any of clauses 1-2, further comprising: at least two additional cartridge assemblies, each comprising an additional nozzle, wherein each cartridge assembly is capable to dispense an ink composition through their respective nozzle; and at least two additional positioning systems, each additional positioning system operatively coupled to one additional cartridge assembly and capable to move the respective nozzles of the one additional cartridge assembly independently of each other nozzle and in at least three degrees of freedom relative to each other nozzle.
Clause 4. The system of any of clauses 1-3, wherein the first positioning system comprises at least three actuators.
Clause 5. The system of clause 4, wherein each of the at least three actuators are operatively coupled to the first cartridge assembly by a linkage assembly.
Clause 6. The system of clause 5, wherein each linkage assembly comprises at least two components selected from the group consisting of a joint, a bar, a spring, and a combination thereof.
Clause 7. The system of any of clauses 5-6, wherein the first cartridge assembly defines a longitudinal axis and the linkage assemblies are substantially evenly spaced about the longitudinal axis.
Clause 8. The system of any of clauses 5-7, wherein each linkage assembly is intermediate the first nozzle and a respective actuator.
Clause 9. The system of any of clauses 4-8, wherein the actuators comprise linear actuators.
Clause 10. The system of any of clauses 1-9, wherein the first cartridge assembly further comprises a cartridge capable of storing ink composition to dispense through the first nozzle.
Clause 11. The system of any of clauses 1-10, further comprising a stage capable of supporting a substrate.
Clause 12. The system of clause 11, further comprising a print head comprising the first cartridge assembly, the second cartridge assembly, the first nozzle positioning system, and the second nozzle positioning system; and a print head positioning system capable to move the print head relative to the stage.
Clause 13. The system of clause 12, wherein the first nozzle positioning system is capable to move the first nozzle while ink composition is being dispensed from the first nozzle.
Clause 14. The system of any of clauses 12-13, wherein the print head positioning system moves the first nozzle positioning system and the second nozzle positioning system simultaneously.
Clause 15. The system of any of clauses 11-14, wherein the first and second nozzle are capable to simultaneously contact the substrate.
Clause 16. The system of any of clauses 11-15, wherein, during extrusion, the first nozzle is intermediate the stage and the first nozzle positioning system.
Clause 17. The system of any of clauses 1-16, wherein the control circuit is further configured to dispense ink composition through the first nozzle at a first rate and the second nozzle at a second rate, wherein the first rate and the second rate are different.
Clause 18. The system of any of clauses 1-17, wherein the control circuit is further configured to dispense ink composition through the first nozzle at a first rate and the second nozzle at a second rate, wherein the first rate and the second rate are the same.
Clause 19. The system of any of clauses 1-18, wherein the control circuit is further configured to dispense ink composition onto a substrate through the first nozzle and the second nozzle, while the first nozzle is at a first distance from the substrate and the second nozzle is at a second distance from the substrate, wherein the first distance and the second distance are different.
Clause 20. The system of any of clauses 1-19, wherein the control circuit is further configured to dispense ink composition onto a substrate through the first nozzle and the second nozzle, while the first nozzle is at a first distance from the substrate and the second nozzle is at a second distance from the substrate, wherein the first distance and the second distance are the same.
Clause 21. The system of any of clauses 1-20, further comprising a detector capable to determine the position, orientation, or a combination thereof of the first and second nozzles.
Clause 22. The system of any of clauses 1-21, further comprising a first feed system configured to apply a pressure to the ink composition in the first nozzle to dispense the ink composition from the first nozzle and onto a substrate.
Clause 23. The system of clause 22, further comprising a second feed system configured to apply a pressure to the second ink composition in the second nozzle to dispense the ink composition from the second nozzle and onto the substrate.
Clause 24. The system of clause 23, wherein the first ink composition and the second ink composition are different.
Clause 25. The system of clause 24, wherein the first ink composition and the second ink composition are the same.
Clause 26. The system of any of clauses 1-25, wherein the first ink composition comprises a viscosity in a range of 20 cP to 10,000,000 cP as measured at 25 degrees Celsius with a rheometer with a 25 mm parallel plate spindle and a shear rate in a range of 0.1 s-1 to 100 s-1.
Clause 27. The system of any of clauses 1-26, wherein the first nozzle comprises a capillary tube having an outer diameter in a range of 0.7 μm to 8 μm.
Clause 28. A method for additive manufacturing, the method comprising: disposing a first nozzle of a first cartridge assembly of an additive manufacturing system over a first location on a substrate; independently of the first nozzle, disposing a second nozzle of a second cartridge assembly of an additive manufacturing system over a second location on a substrate; dispensing a first ink composition from the first nozzle onto the first location of the substrate and dispensing a second ink composition from the second nozzle onto the second location of the substrate, thereby forming a first portion of a structure on the first location and a second portion of the structure on the second location; and repeating, as necessary, repositioning of the first nozzle and the second nozzle over the substrate and dispensing ink composition from the first nozzle, the second nozzle, or a combination thereof, thereby forming the structure on the substrate. at least two additional positioning systems, each additional positioning system operatively coupled to one additional cartridge assembly and capable to move the respective nozzles of the one additional cartridge assembly independently of each other nozzle and in at least three degrees of freedom relative to each other nozzle.

In a general sense, those skilled in the art will recognize that the various aspects described herein which can be implemented, individually and/or collectively, by a wide range of hardware, software, firmware, or any combination thereof can be viewed as being composed of various types of electrical circuits referred to herein as a control circuit. Consequently, as used herein an “electrical circuit” includes, but is not limited to, a control circuit having at least one discrete electrical circuit, a control circuit having at least one integrated circuit, a control circuit having at least one application specific integrated circuit, a control circuit forming a general purpose computing device configured by a computer program (e.g., a general purpose computer configured by a computer program which at least partially carries out processes and/or devices described herein, or a microprocessor configured by a computer program which at least partially carries out processes and/or devices described herein), a control circuit forming a memory device (e.g., forms of random access memory), and/or a control circuit forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof, collectively referred to herein as a control circuit. In one form, several portions of the subject matter described herein may be implemented via ASIC, FPGA, DSP, or other integrated formats. However, those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuit and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative form of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

As used herein, a referenced element or region that is “intermediate” two other elements or regions means that the referenced element/region is disposed between, but is not necessarily in contact with, the two other elements/regions. Accordingly, for example, a referenced element that is “intermediate” a first element and a second element may or may not be immediately adjacent to or in contact with the first and/or second elements, and other elements may be disposed between the referenced element and the first and/or second elements.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited.

The grammatical articles “a,” “an,” and “the,” as used herein, are intended to include “at least one” or “one or more,” unless otherwise indicated, even if “at least one” or “one or more” is expressly used in certain instances. Thus, the articles are used herein to refer to one or more than one (i.e., to “at least one”) of the grammatical objects of the article. Further, the use of a singular noun includes the plural, and the use of a plural noun includes the singular, unless the context of the usage requires otherwise.

Any patent, publication, or other disclosure material identified herein is incorporated by reference into this specification in its entirety unless otherwise indicated, but only to the extent that the incorporated material does not conflict with existing descriptions, definitions, statements, or other disclosure material expressly set forth in this specification. As such, and to the extent necessary, the express disclosure material as set forth in this specification supersedes any conflicting material incorporated by reference. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

One skilled in the art will recognize that the herein described components (e.g., operations), devices, and objects, as well as the discussion accompanying them, are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

One skilled in the art will recognize that the herein-described components, devices, operations/actions, and objects, as well as the discussion accompanying them, are used as examples for the sake of conceptual clarity and that various configuration modifications are contemplated. Consequently, as used herein, the specific examples/embodiments set forth and the accompanying discussions are intended to be representative of their more general classes. In general, use of any specific exemplar is intended to be representative of its class, and the non-inclusion of specific components, devices, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the present disclosure should be understood to be at least as broad as it is claimed and not as more narrowly defined by particular illustrative aspects provided herein.

What is claimed is:

1. An additive manufacturing system, the system comprising:
a first cartridge assembly comprising a first nozzle, wherein the first cartridge assembly is capable to dispense an ink composition through the first nozzle;
a second cartridge assembly comprising a second nozzle, wherein the second cartridge assembly is capable to dispense an ink composition through the second nozzle;
a first nozzle positioning system operatively coupled to the first cartridge assembly and capable to move the first nozzle independently of the second nozzle and in at least three degrees of freedom relative to the second nozzle;
a second nozzle positioning system operatively coupled to the second cartridge assembly capable to move the second nozzle independently of the first nozzle and in at least three degrees of freedom relative to the first nozzle; and
a control circuit in electrical communication with the first cartridge assembly, the second cartridge assembly, the first positioning system, and the second positioning system, wherein the control circuit is capable to dispense an ink composition through the first nozzle and the second nozzle utilizing the first cartridge assembly and the second cartridge assembly.

2. The system of claim 1, further comprising:
a third cartridge assembly comprising a third nozzle, wherein the third cartridge assembly is capable to dispense an ink composition through the third nozzle; and
a third positioning system operatively coupled to the third cartridge assembly and capable to move the third nozzle independently of the first and second nozzles and in at least three degrees of freedom relative to the first and second nozzles.

3. The system of claim 1, further comprising:
at least two additional cartridge assemblies, each comprising an additional nozzle, wherein each cartridge assembly is capable to dispense an ink composition through their respective nozzle; and
at least two additional positioning systems, each additional positioning system operatively coupled to one additional cartridge assembly and capable to move the respective nozzles of the one additional cartridge assembly independently of each other nozzle and in at least three degrees of freedom relative to each other nozzle.

4. The system of claim 1, wherein the first positioning system comprises at least three actuators.

5. The system of claim 4, wherein each of the at least three actuators are operatively coupled to the first cartridge assembly by a linkage assembly.

6. The system of claim 5, wherein each linkage assembly comprises at least two components selected from the group consisting of a joint, a bar, a spring, and a combination thereof.

7. The system of claim 5, wherein the first cartridge assembly defines a longitudinal axis and the linkage assemblies are substantially evenly spaced about the longitudinal axis.

8. The system of claim 5, wherein each linkage assembly is intermediate the first nozzle and a respective actuator.

9. The system of claim 1, further comprising
a stage capable of supporting a substrate;
a print head comprising the first cartridge assembly, the second cartridge assembly, the first nozzle positioning system, and the second nozzle positioning system; and
a print head positioning system capable to move the print head relative to the stage.

10. The system of claim 9, wherein the first nozzle positioning system is capable to move the first nozzle while ink composition is being dispensed from the first nozzle.

11. The system of claim 9, wherein the print head positioning system moves the first nozzle positioning system and the second nozzle positioning system simultaneously.

12. The system of claim 9, wherein the first and second nozzle are capable to simultaneously contact the substrate.

13. The system of claim 9, wherein, during extrusion, the first nozzle is intermediate the stage and the first nozzle positioning system.

14. The system of claim 1, further comprising a detector capable to determine the position, orientation, or a combination thereof of the first and second nozzles.

15. The system of claim 1, further comprising:
a first feed system configured to apply a pressure to the ink composition in the first nozzle to dispense the ink composition from the first nozzle and onto a substrate; and
a second feed system configured to apply a pressure to the second ink composition in the second nozzle to dispense the ink composition from the second nozzle and onto the substrate.

16. The system of claim 15, wherein the first ink composition and the second ink composition are different.

17. The system of claim 15, wherein the first ink composition and the second ink composition are the same.

18. The system of claim 1, wherein the first ink composition comprises a viscosity in a range of 20 cP to 10,000,000 cP as measured at 25 degrees Celsius with a rheometer with a 25 mm parallel plate spindle and a shear rate in a range of 0.1 s⁻¹ to 100 s⁻¹.

19. The system of claim 1, wherein the first nozzle comprises a capillary tube having an outer diameter in a range of 0.7 μm to 8 μm.

20. A method for additive manufacturing, the method comprising:
disposing a first nozzle of a first cartridge assembly of an additive manufacturing system over a first location on a substrate;
independently of the first nozzle, disposing a second nozzle of a second cartridge assembly of an additive manufacturing system over a second location on a substrate;
dispensing a first ink composition from the first nozzle onto the first location of the substrate and dispensing a second ink composition from the second nozzle onto the second location of the substrate, thereby forming a first portion of a structure on the first location and a second portion of the structure on the second location; and
repeating, as necessary, repositioning of the first nozzle and the second nozzle over the substrate and dispensing ink composition from the first nozzle, the second nozzle, or a combination thereof, thereby forming the structure on the substrate.
